(19) United States
(12) Patent Application Publication
(10) Pub. No.: US 2006/0026503 A1
(43) Pub. Date: Feb. 2, 2006

(54) Markup document appearance manager

(75) Inventors: David M. Bartosh, Seattle, WA (US); Hector E. Chejfec, Bellevue, WA (US); Curtis L. Miller, Sammamish, WA (US); Eric E. Lofdahl, Kent, WA (US); John H. Kuhlmann, Mercer Island, WA (US); David N. Hoogerwerf, Snohomish, WA (US); Kristine G. Siebert, Issaquah, WA (US); Larry A. Setlow, Redmond, WA (US); Alan C. Lindsay, Edmonds, WA (US)

Correspondence Address: DARBY & DARBY P.C., P. O. BOX 5257, NEW YORK, NY, 10150-5257, US

(73) Assignee: Wireless Services Corporation, Bellevue, WA (US)

(21) Appl. No.: 11/101,030

(22) Filed: Apr. 6, 2005

Related U.S. Application Data
(60) Provisional application No. 60/592,445, filed on Jul. 30, 2004.

(51) Int. Cl. G06F 17/21; G06F 17/24

(52) U.S. Cl. 715/513; 715/530; 715/511

(57) ABSTRACT

An appearance manager for editing and previewing a portion of a Web page, such as a header and/or a footer. A browser-based appearance manager user interface enables a user to edit, validate, and store source markup code of the portion of the Web page without affecting a corresponding deployed Web page. The appearance manager can render the portion of the Web page separate from the remainder of the corresponding deployed Web page or together with the remainder of the corresponding deployed Web page. In either case, the rendering is done separate from the corresponding deployed Web page, so as not to affect the deployed Web page, which is accessible to client browsers. When rendering together, the appearance manager accesses and applies the same stylesheet that is applied to the corresponding deployed Web page. Thus, the user can preview revised portions of the Web page as they will appear when deployed.

### CROSS-REFERENCE TO RELATED APPLICATIONS

This application claims the benefit of U.S. Provisional Patent Application 60/592,445 filed Jul. 30, 2004, the contents of which are hereby incorporated by reference.

### FIELD OF THE INVENTION

The present invention is directed to managing the appearance of a rendered markup document, and more specifically to enabling a user to edit, preview, and deploy revised markup documents using a remote stylesheet.

### BACKGROUND OF THE INVENTION

Markup documents can be created and rendered with a number of computing languages, including hypertext markup language (HTML), extensible hypertext markup language (XHTML), extensible markup language (XML), standard generalized markup language (SGML), and the like. Some editors enable a user to create, edit, and view markup documents in a local environment. A markup document is generally made available to other users by deploying the markup document to a computing device that is accessible to others through a network. The other users can then view a rendered version of the markup document with a browser program.

Revisions to the markup document are generally made in a local editing environment, and the revised markup document is deployed to replace a previous version of the markup document. Some markup documents include portions that a user wishes to remain the same, and portions that the user wishes to change whenever desired. To make changes with currently known techniques, the entire markup document is generally loaded into an editor, and the desired portions are revised. The entire revised markup document is then deployed to replace the previous version.

A deployed markup document can be rendered according to a stylesheet that defines some overall formatting. The overall formatting can be over-ridden by in-line formatting instructions within the markup document. The stylesheet is typically stored on the same computing device as the deployed markup document. The stylesheet may not be available to all users who wish to revise a portion of the markup document. Thus, it is sometimes uncertain how a revised markup document will appear when rendered. The present invention is generally directed to addressing the above, and other issues.

### BRIEF DESCRIPTION OF THE DRAWINGS

FIG. 1 shows a functional block diagram of an exemplary server according to one embodiment of the invention;

FIG. 2 is a functional block diagram illustrating an overall architecture of an exemplary embodiment of the present invention;

FIG. 3 is a screen print illustrating a deployed markup document that is rendered by a client browser;

FIG. 4 is screen print illustrating a header/footer manager user interface for revising a header portion of a markup document through an administrator's browser; and

FIG. 5 is a flow diagram illustrating exemplary overall logic for revising, previewing, and deploying a header and/or footer of a markup document.

### DETAILED DESCRIPTION OF THE INVENTION

The present invention will now be described with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification, the term “connected” means a direct connection between the things that are connected, without any intermediary devices or components. The term “coupled,” or “in communication with” means a direct connection between the things that are connected or an indirect connection through one or more either passive or active intermediary devices or components. The meaning of “a,” “an,” and “the” include plural references. The meaning of “in” includes “in” and “on.”

The terms “deployed document” or “deployed version” generally refer to a markup document, or a portion of a markup document, that is accessible to users via a network such as the Internet. The term “primary document” generally refers to a markup document that includes source markup code for a main body of a Web page, which is generally deployed for access by users via the network. The primary document can refer to associated markup documents, which comprise versions of headers and/or footers that can be rendered together with the primary document. Alternatively, the primary document can incorporate source markup code for a header and/or footer that are stored in a database table or stored in separate, but associated markup documents. The terms “preview document,” “preview version,” or “non-reversible document” generally refer to an associated markup document, or source markup code in a database table, that is not generally available to users via the network, but can be locally edited and overwritten by an administrator such that previous versions can not be restored in a deployed document. The terms “active document,” “active version,” or “reversible document” generally refer to an associated markup document, or source markup code in a database table, that is not yet deployed for general access to users via the network, but can be deployed to become a deployed document or part of a deployed document (e.g., part of a deployed primary document). An active document can be locally edited and saved by an administrator such that a previous version of the active document is stored as a “rollback document” that can be restored as a deployed document or part of a deployed document. The terms “rollback document,” “rollback version,” or “backup document” generally refer to a markup document, or source markup code in a database table, that comprises a previous version of an active document, which can be restored as a deployed document or part of a deployed document.

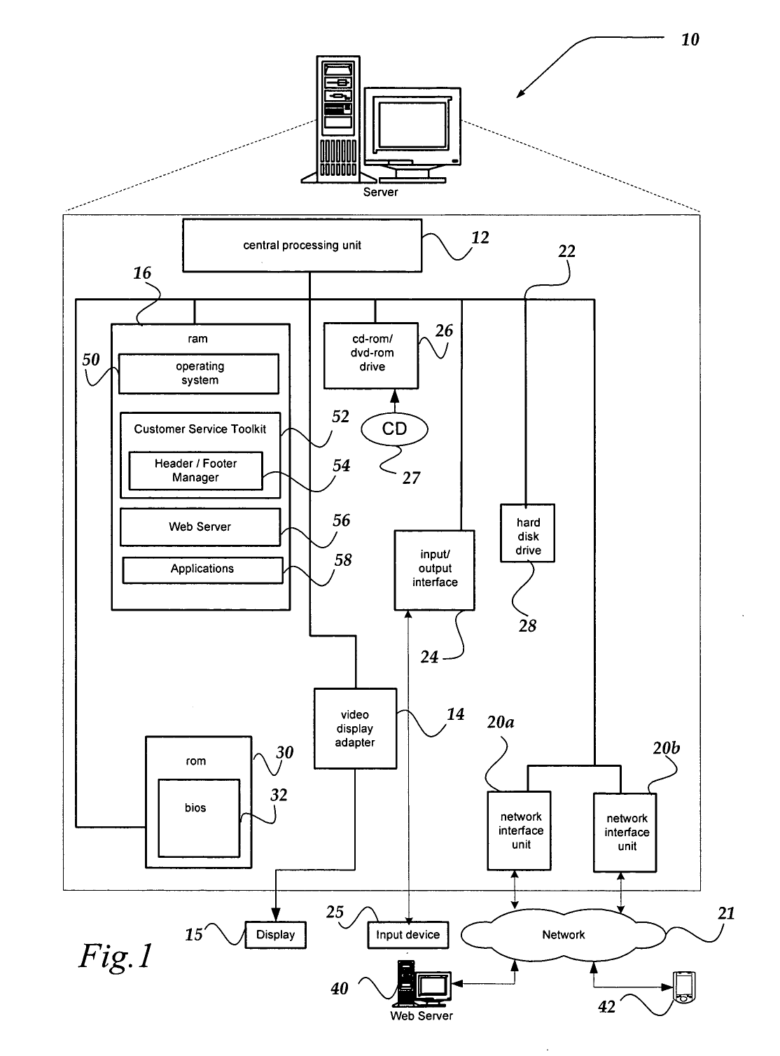

Briefly stated, the invention is direct to a method and system for editing, previewing, and deploying at least a portion of a markup document using a stylesheet defining formatting for a deployed primary document and/or associated documents. FIG. 1 shows a functional block diagram of an exemplary server 10, according to one embodiment of the invention. Server 10 may include many more components than those shown. The components shown, however, are sufficient to disclose an illustrative embodiment for practicing the invention. Client devices can be similarly configured. Client devices can include, but are not limited to, other servers, personal computers (PCs), PDAs, mobile terminals (e.g., cell phones), voice mail systems, and the like. A recipient can also receive messages via other forms of communication, such as fax, voice mail, postal mail, and the like.

Server 10 includes a processing unit 12, a video display adapter 14 that can drive a display 15, and a mass memory, all in communication with each other via a bus 22. The mass memory generally includes RAM 16, ROM 30, and one or more permanent mass storage devices, such as an optical drive 26 that can read a machine readable medium such as a CD 27, a hard disk drive 28, a tape drive, and/or a floppy disk drive. The mass memory stores an operating system 50 for controlling the operation of server 10. Any general-purpose operating system may be employed. A basic input/output system (“BIOS”) 32 is also provided for controlling low-level operation of server 10.

The mass memory also includes computer-readable media, such as volatile, nonvolatile, removable, and non-removable media implemented in any method or technology for storage of information, such as computer readable instructions, data structures, program modules, or other data. Examples of computer-readable media include RAM, ROM, EEPROM, flash memory, or other memory technology, CD-ROM, digital versatile disks (DVD), or other optical storage, magnetic cassettes, magnetic tape, magnetic disk storage, or other magnetic storage devices, or any other medium which can be used to store the desired information and which can be accessed by a computing device.

The mass memory also stores program code and data. One or more applications 58 are loaded into mass memory and run on operating system 50. Examples of application programs include database programs, schedulers, transcoders, email programs, calendars, web services, word processing programs, spreadsheet programs, and so forth. Mass storage may further include applications such as a request handler 52 for managing communication requests from senders, an authenticator for authenticating a sender, a message transmitter 56 for communicating with a recipient, and the like.

Server 10 also includes input/output interface 24 for communicating with external devices, such as a mouse, keyboard, scanner, or other input devices 25. Server 10 can communicate with the Internet, a telephone network, a postal network, or some other communications network via network interface units 20a and 20b, which are constructed for use with various communication protocols including transmission control protocol/Internet protocol (TCP/IP), user datagram protocol (UDP), code division multiple access (CDMA), time division multiple access (TDMA), global system for mobile communications (GSM), Institute for Electrical and Electronics Engineers (IEEE) 802.11, IEEE 802.16 (WiMax), SMS, general packet radio service (GPRS), Wireless Application Protocol (WAP), and the like. Network interface units 20a and 20b are sometimes known as transceivers, transceiving devices, network interface cards (NICs), and the like. The network interface units can facilitate communications between computing devices that conform to the same or differing communication protocols. For example, network interface units 20a and 20b are illustrated as communicating with a network 21, such as the Internet. Network 21 provides communication services for conforming server and/or client devices, such as a Web server 40 that stores deployed Web pages for access through a browser program run on client devices such as a WAP-enabled PDA 42.

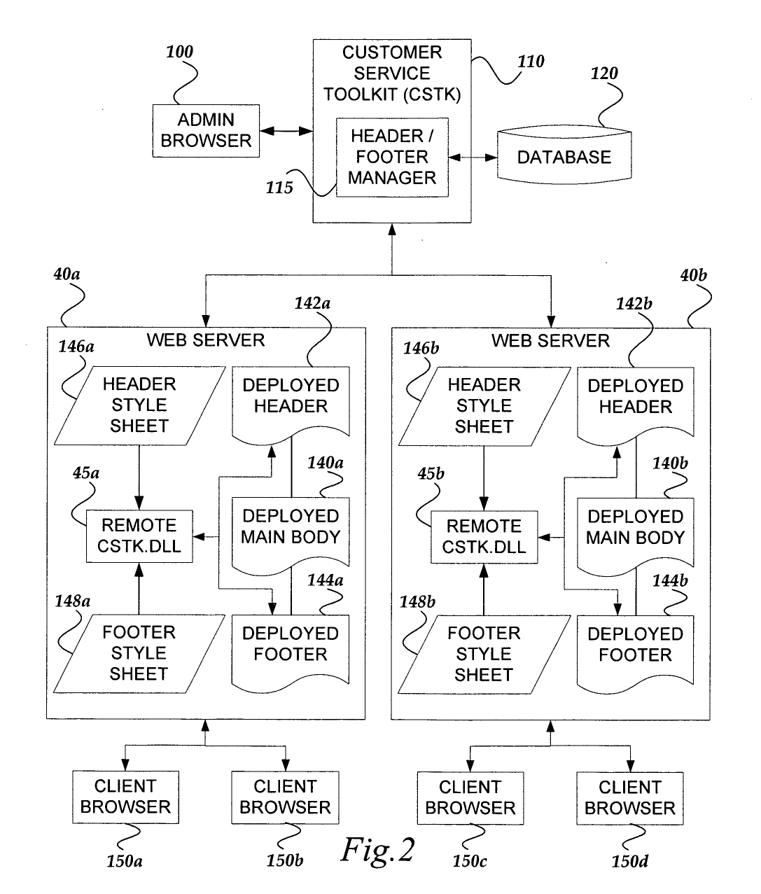

FIG. 2 is a functional block diagram illustrating an overall architecture of an exemplary embodiment of the present invention that manages headers and footers of Web pages.

An administrator, or other authorized user, uses a browser 100 to interact with a customer service toolkit (CSTK) 110. The CSTK provides a number of service modules that enable the administrator to manage an electronic messaging service. CSTK 110 can be implemented as a dynamic link library (e.g., CustToolkit.dll) and provide a browser-based interface for managing services such as modifying a header and footer displayed on text messaging Web sites (e.g., as rendered by iPageExt.dll and associated XSL stylesheets). CSTK 110 includes a header/footer manager 115 that enables the administrator to manage headers and/or footers for Web pages associated with the electronic messaging service. CSTK 110 and header/footer manager 115 communicate with a database 120 that stores preview documents (non-reversible documents), active documents (reversible documents), rollback documents (backup documents), stylesheets, and other information.

CSTK 110 and header/footer manager 115 also communicate with one or more remote computing devices such as Web servers 40a and 40b. Each remote computing device includes a remote CSTK dynamic link library, such as CSTK.DLLs 45a and 45b. The CSTK.DLLs provide information from the Web servers to CSTK 110, and coordinate deployment of headers and footers associated with deployed Web pages. Deployed Web pages are duplicated across the Web servers. A deployed Web page generally includes a main body such as deployed main bodies 140a and 140b. The deployed main bodies are sometimes referred to as primary markup documents. Associated with each main body can be a header, such as deployed headers 142a and 142b. Additionally, or alternatively associated with each main body is a footer, such as deployed footers 144a and 144b. The header and/or footer are generally stored as separate, but associated markup documents to which a main body refers for rendering together with the main body (i.e., together with the primary markup document). Also associated with the deployed Web pages are one or more stylesheets, such as header stylesheets 146a and 146b, and/or footer stylesheets 148a and 148b. A single overall stylesheet can also be applied to the main body, the header, and/or the footer. CSTK 110 generally obtains a copy of the deployed header, deployed footer, and corresponding stylesheet(s) when a header or footer is to be edited. The copy of the deployed header or deployed footer becomes an initial active document and an initial rollback document, which can be redeployed if a revised active document is not acceptable.

With header/footer manager 115, an administrator can edit and preview the active document, utilizing the corresponding stylesheet to view the revised header or footer as it would appear if it were deployed. Once satisfied with the revised header or footer, the administrator saves the revised header or footer as a current active document. Header/footer manager 115 can then deploy the current active document by sending an HTTP URL to the CSTKL.DLL on each Web server with an instruction to deploy the currently active document (i.e., the currently active header or footer markup document). A sample URL is as follows:
http://WebServer1/cgi/CSTK.dll?PageID=ActivePage&DeployActive=true
   Once an active document is deployed, the new header or footer is immediately accessible with the deployed main body to end users through client browsers 150a-150d.

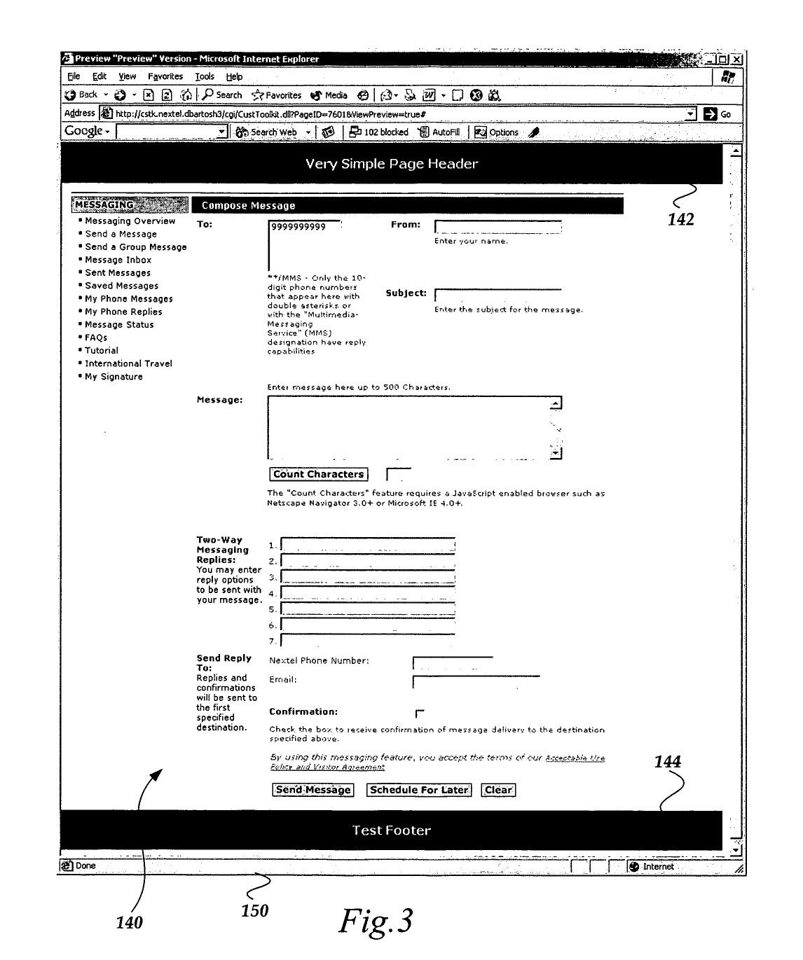

FIG. 3 is a screen print illustrating a sample deployed markup document that is rendered by a browser. The document will be rendered the same by an administrator's browser as the document would be rendered by a client browser. The sample deployed document includes a main body 140, which comprise a data submission form for sending a text message to a mobile client device. Associated with main body 140 are a sample header 142 and a sample footer 144, which can be customized with the header/footer manager without editing the entire deployed markup document.

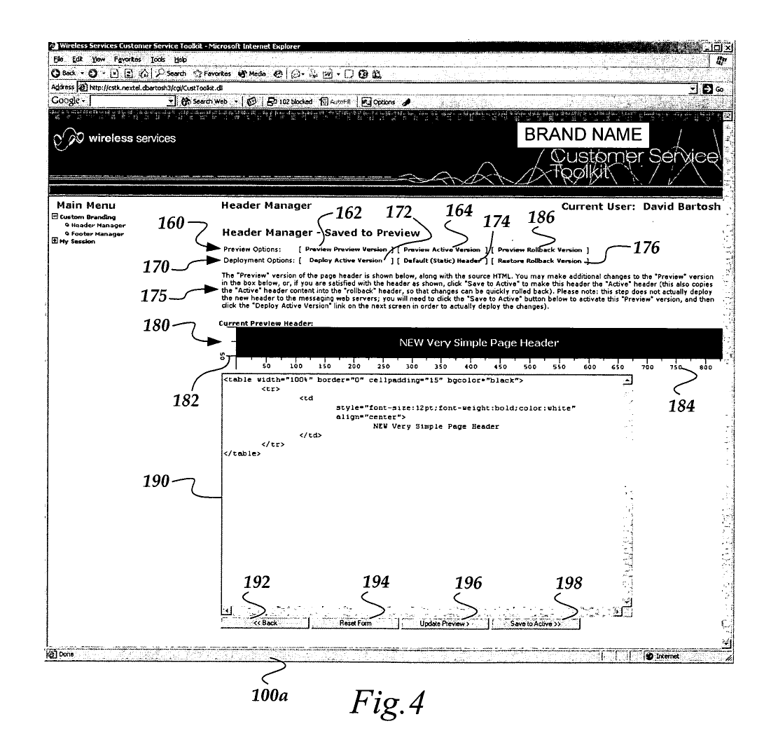

FIG. 4 is a screen print illustrating a sample view of a header/footer manager user interface that is operating in its header manager mode to enable an administrator to edit a header through the administrator's browser 100a. The header/footer manager display is divided into a number of portions. One portion includes a set of preview options 160 that enable the administrator to preview different versions of the header as the different versions would appear if they were rendered in the full Web page with the main body. Another portion includes a set of deployment options 170 that enable the administrator to deploy one of a number of versions of the header. A explanation portion 175 provides a textual description of a current status and/or options available to the administrator.

A preview portion 180 displays a selected version of the header as it would be rendered with the corresponding header stylesheet in a client browser (or with an overall stylesheet that also applies formatting to the main body). Preview portion 180 also includes a vertical ruler 182 and a horizontal ruler 184 for size references. A source text area 190 displays the source markup code for the currently displayed header in preview portion 180. The source markup code is chosen and written to be compatible with a stylesheet transformation engine used by the Web servers. For example, the source markup code can be XHTML code that is well formed and otherwise compatible with an extensible stylesheet (XSL) transformation engine, such as the Xalan-C++ processor and libraries, provided by the Apache Software Foundation. The administrator can edit the source markup code, including adding in-line formatting to override the stylesheet and/or adding script code. The administrator can also select a currently available editing option, such as editing options 192-198, to store or recover previous source markup code. For instance, a backup option 192 enables the administrator to undo one or more recent edits in source text area 190. A reset form option 194 enables the administrator to reset the source markup code in source text area 190 to the markup code shown when the header (or footer or other portion of the Web page) was loaded with the header/footer manager. Conversely, an update preview option 196 enables the administrator to save the current source markup code in source text area 190 to the preview document. This option causes the header/footer manager to evaluate the current source markup code for syntactical and other errors. If any errors are found the header/footer manager displays an error message and does not overwrite the preview document. However, if no errors are found, the header/footer manager overwrites the preview document. The previous version of the preview document can not be recovered for reediting and/or redeployment. The header/footer manager also updates preview portion 180 to render the newly saved preview document. This enables the administrator to preview the header without having to preview the entire Web page to see the new preview document rendered.

Alternatively, a save to active option 198 enables the administrator to save the current source markup code in source text area 190 to the active document. This option causes a previous version of the active document to be saved to the rollback document before the current active document is overwritten with the current preview document. The rollback document can then be used to recover the previous version of the active document for reediting and/or redeployment. The header/footer manager also updates preview portion 180 to render the newly saved active document. This enables the administrator to preview the header without having to preview the entire Web page to see the new active document rendered. Other editing options may be available based on the current state of the header/footer manager.

When the administrator wishes to preview one of the stored documents for a header or footer with the main body to see the entire Web page, the administrator can select one of the preview options. For instance, a “Preview Preview Version” option 162 causes the header/footer manager to apply the corresponding stylesheet to the currently stored preview document along with a copy of the main body and the footer to render the whole Web page in a new browser window with the resulting transformed preview document. A “Preview Active Version” option 164 causes the header/footer manager to apply the corresponding stylesheet to the currently stored active document along with the copy of the main body and the footer to render the whole Web page in a new browser window with the resulting transformed active document. Similarly, a “Preview Rollback Version” option 166 causes the header/footer manager to apply the corresponding stylesheet to the currently stored rollback document along with the copy of the main body and the footer to render the whole Web page in a new browser window with the resulting transformed rollback document.

When the administrator wishes to deploy one of the stored documents, the administrator can select one of the deployment options. For example, a “Deploy Active Version” option 172 causes the header/footer manager to copy the currently stored active document to the Web servers, and issue the HTTP URL that causes the CSTK.DLLs to replace a currently deployed header with the active document. If any error occurs in copying the currently stored active document and/or in performing the instructions of the URL, a message is displayed to the administrator. If the deployment is successful, and a client requests the Web page, the newly deployed active document will be rendered in the client's browser as the header along with the main body. Thus, a new header is immediately deployed without having to revise or redeploy the previously deployed main body and footer of the Web page. The same is true if a footer, or other portion of the Web page is revised and deployed with the CSTK. As another example, a “Default (Static) Header” option 174 causes the header/footer manager to write an empty header file to each Web server. This causes a default header to be rendered rather than any header created with the header/footer manager. This enables the administrator to immediately deploy a header (or footer, or other portion of the Web page) that is known to be acceptable. A “Restore Rollback Version” option 176 causes the header/footer manager to replace the most recent active header document with a rollback version of the header document. The rollback version of the header document is then considered the current active header document. The administrator can then use the “Deploy Active Version” option to issue the HTTP URL that causes the CSTK.DLLs to replace a currently deployed header with the current active version of the header document, which is actually the rollback version of the header document. This deploys a previous version of the active document. Additional rollback documents can be stored to enable sequential deployment of a series of previous versions of a header, footer, and/or other portion of a Web page.

Process Descriptions

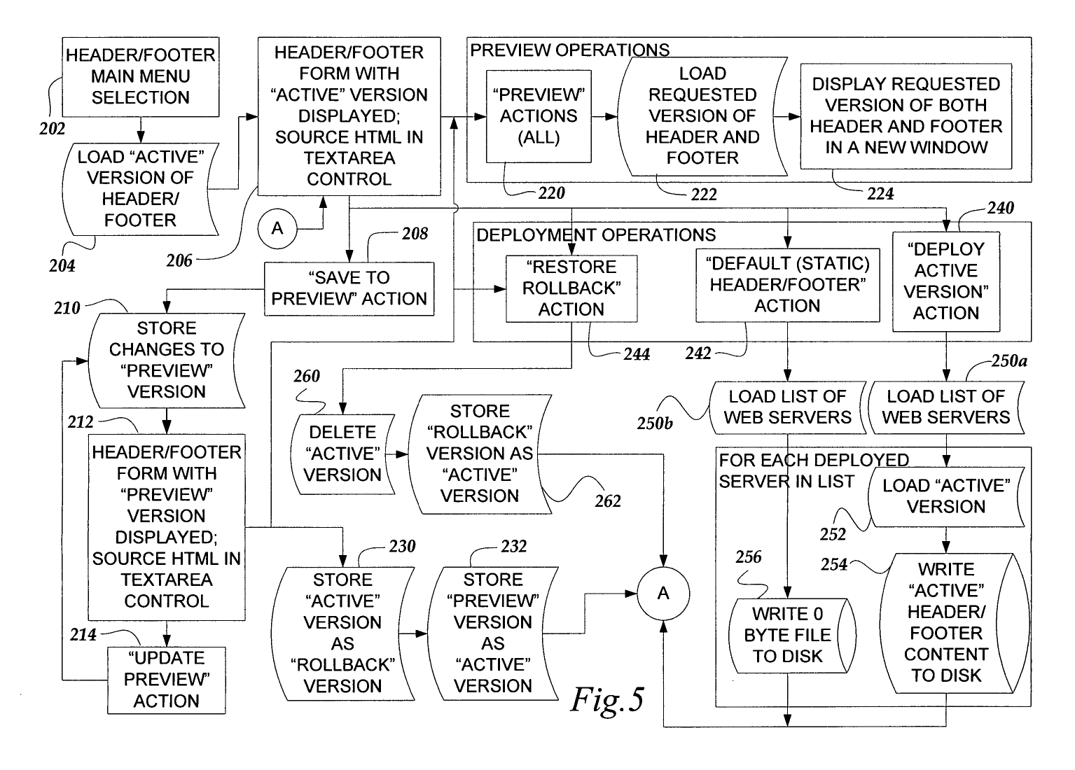

FIG. 5 is a flow diagram illustrating exemplary overall logic for revising, previewing, and deploying a header and/or a footer. The operations of this exemplary logic and other operations can be performed in a plurality of sequences in addition to those described below. As described above, there are three documents (or three versions of source markup code) for the header and three documents (or three versions of source markup code) for the footer. These three documents or versions are referred to as “preview,” “active” and “rollback.” The preview version (the preview document or the preview source markup code stored in the database) is generally intended to be used for designing or testing the presentation of the page header or footer. This preview version of code should not be confused with the “preview” operations available through the header/footer manager user interface, wherein one of these code versions are selected by the administrator and rendered in a new browser window along with the main body of the Web page. The “active” version generally acts a last checkpoint, where the administrator can use either the preview portion of the user interface, or use the separate “Preview Active Version” browser window to confirm that the header/footer meets the administrator's requirements, before deploying a new header/footer design to each of the Web servers. The “rollback” version is written when the “Save to Active” option is chosen. This is done so that the “Restore Rollback” option may be used to revert back to the last saved active version.

In an exemplary embodiment, each version is stored in the database in a table, such as a table named “tblCustomText.” This table will also maintain information about the date/time that a version was created, the UserID of the administrator who made a change, and the date/time of the last change to a row along with the UserID of the person who made the last change. If a row does not exist (i.e.—the selected version is being inserted into the database for the first time), a ChangedBy (UserID) field and a ChangedAt (Current Date/Time) field are left with NULL values.

Also, user-defined data should reside in a common location on each production Web server, such as each text messaging Web server. For example, a possible path for storing user-defined data files is:
D:\Nibserv\WebContent
   This folder matches the path described by a “WebContentFilePath” entry in the database. The WebContentFilePath is a configuration parameter common to the production Web servers. On each of the production Web servers, an empty (0 byte) “customHeader.txt” and “customFooter.txt” file should be placed in the folder designated above. These files comprise a default header and footer until filled with other custom header and footer source markup code. Accordingly, possible paths for storing these files are:
D:\Nibserv\WebContent\customHeader.txt
D:\Nibserv\WebContent\customFooter.txt

Editing Versions of a Header or Footer

After the above configuration operations are performed, and an administrator successfully logs into the CSTK, a CSTK “Main Menu” is displayed at an operation 202, which enables the administrator to select a header manger or a footer manager. At an operation 204, a current active version of a corresponding page header or page footer is loaded, as determined by the administrator's selection from the CSTK Main Menu. To simplify the following description, we assume that the administrator selected a header to revise with the header manager, unless otherwise stated. A header manager user interface page, such as that illustrated in FIG. 4, is loaded by the administrator browser. The stored active version of the header is displayed in the preview portion of the user interface page at an operation 206. The displayed active header is labeled in the user interface page as a “Current Active Header” section. This section includes the horizontal and vertical rulers, so that the administrator can visually make judgments as to the appropriateness of the header size. The source text area comprises an input field (e.g., a form control) showing the current XHTML-compliant source markup code. If no active version exists, then both the “Current Active Header” section and the source text area will be empty.

The administrator can then make changes to the source markup code in the source text area. When desired, the administrator selects a “Save To Preview” option, at an operation 208, to save the changed source markup code to the “Preview” version of the header at an operation 210. The CSTK also stores the date and time at which the header is updated. In general, for any save operation, the CSTK will store the date and time at which any version of the header or footer is updated. The CSTK also stores the UserID (e.g., the logged in administrator's UserID) of the last person to make changes to the header or footer. Each “save” operation on any version will cause the administrator-provided data (e.g., XHTML-compliant source markup) to be run through an XML parser for validation before writing the record. For example, the CSTK can invoke the Xerces-C++ XML parser and libraries, provided by Apache Software Foundation, or the like. Several “parse errors” may be returned by the application, should the HTML contain invalid (non-XHTML-compliant) markup. If no errors occur, the preview version of the selected header is rendered and displayed in the administrator browser at an operation 212. Also displayed is the newly saved source markup code in the text area of the administrator browser window. The administrator can make additional changes to the source markup code and update the saved preview version of the header at an operation 214.

Preview Operations

The header manager (and Footer Manager) allows the administrator to preview the “preview” version of the header (and footer) in the context of the final presentation of a currently deployed Web page such as the “Compose Message” sample Web page illustrated in FIG. 3. By displaying a complete Web page, the administrator can decide on the fitness of the preview version of the header in relation to the rest of the currently deployed Web page. As discussed in more detail below, the administrator can also preview the “active” version of the header in the context of the remainder of the currently deployed Web page. The administrator can further preview the “rollback” version of the header if desired. Any one of these versions can be selected at an operation 220 of FIG. 5 by clicking on the corresponding preview option described with regard to FIG. 4. At an operation 222 of FIG. 5, the requested version is loaded along with a copy of the currently deployed Web page (e.g., the main body). Also accessed is a copy of a stylesheet corresponding to the currently deployed Web page. The header manager will then launch a new browser window at an operation 224, which renders the same version of both the header and footer along with the main body of the currently deployed Web page according to the stylesheet. In this way, the administrator can see the selected version of the header and footer as it would be deployed on the Web servers and appear in client browsers, before the selected version is actually deployed.

If a previously stored version of the header or the footer does not exist, then the words “No Stored ‘[Preview|Active|Rollback]’ [Header|Footer]” are displayed within two horizontal rule (<hr>) elements. For example, if the “Preview” version of the page header does not exist, then the page will show the following message:
No Stored “Preview” Header

Operations on Active Version

If satisfied with the preview version of the header, the administrator can save the preview version as the active version. The active version is not to be confused with a header that is deployed on the Web servers, and is not to be confused with the most recently previewed version of the header. The active version can be used to store a version of the header that the administrator currently feels is the best revision so far, while the administrator continues to make further revisions to the preview version. When the administrator believes that a current revision of the preview version is better than the current active version, the administrator can select to save the preview version as the active version. The “Save to Active >>” option 198 of FIG. 4, causes the header manager to perform two replacements. First, the header manager will copy the content of the current active version to the rollback version of the header, at an operation 230 of FIG. 5. This ensures that any errors or changes can be quickly undone using the “Restore Rollback” option. Second, the header manager replaces the current active version with the contents of the previously-stored preview version at an operation 232. The header manager ignores the current contents of the source text area. Once the versions are replaced, the header manager displays the newly-stored active version and corresponding source code in the administrator browser at operation 206, via connector A. Thus, the “Save to Active >>” option is a next logical step in the process of confirming a desirable result before deploying the newly-designed header. It is believed that providing a multi-step process will help reduce the likelihood of an undesired header being deployed.

Deployment Operations

As indicated above, there are three essential deployment operations: a “Deploy Active Version” operation 240, a “Default (Static) Header/Footer” operation 242, and a “Restore Rollback” operation 244. The “Deploy Active Version” operation causes the header manager to obtain a list of Web servers at an operation 250a, and instruct each of them to deploy the current active version of the header. The list of servers is derived from database entries that correspond to a configuration parameter common to and accessible by the Web servers which operate the Customer Service Toolkit (e.g., CSTK.DLL) for the purpose of utilizing the invention.

Deployment is handled by an instance of the remote Customer Service Toolkit (e.g., CSTK.DLL) running on each Web server. In an exemplary embodiment, each Web server acts as a host to a text messaging Web site. The Customer Service Toolkit loads the active version of the header at an operation 252, and writes the active version to the Web server's deployment storage at an operation 254. The active version of the header is then immediately available to any client browsers that request a Web page that is associated with the header. Thus, customized headers, footers, and/or other portions of a Web page can be dynamically updated without the need to re-deploy the whole Web page.

Rollback Operations

If the administrator determines that a currently deployed custom header is undesired, the header manager enables the administrator to remove any custom header or return to a previous version of the header. To remove any custom header, the administrator selects the “Default (Static) Header/Footer” option. This option causes the header manager to obtain a list of Web servers at an operation 250b, and instruct each of them to overwrite the currently deployed custom header with a zero byte file at an operation 256. The zero byte file causes the Customer Service Toolkit on each Web server to provide the main body of the Web page to any requesting client browser that includes no header markup code or default header markup code, which would not be superceded by custom header markup code. A default header can include some generic content or no content at all. The header manager also refreshes the administrator browser with the active version of the header at operation 206 via connector A.

The administrator can also return deployed Web pages to a previous version of the custom header, or return the currently active version of the header to a previously saved version. For these operations, the administrator selects the “Restore Rollback Version” option of the header manager via the administrator browser. At an operation 260, the header manager deletes the currently active version of the header stored in the database of the administrator computing system (or could store it as a rollforward version). The header manager then accesses a previously stored rollback version of the header and stores this rollback version as the active version, at an operation 262. A similar result can be achieved by overwriting the currently active version of the header with the rollback version. The “Restore Rollback Version” option generally has no direct effect on the deployed presentation of the site. Instead, the option is designed to be a reverse of the “Save to Preview” operation that essentially re-writes a known good state of the header (i.e., the rollback version), back into the active version. The newly restored active version can then be quickly re-deployed using the “Deploy Active Version” option. This effectively replaces a currently deployed header on the Web servers with the rollback version of the header. The header manager also refreshes the administrator browser with the newly restored active version of the header at operation 206 via connector A.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A method for managing a rendered appearance of a markup document, comprising:
accessing a stylesheet that defines formatting for rendering the markup document;
enabling a user to edit an associated portion of the markup document with an administrator browser, wherein the associated portion is selectively deployable with a remaining portion of the markup document for access by a client browser; and
enabling a user to preview with the administrator browser a rendering of the markup document including the associated portion according to the formatting defined by the stylesheet, prior to selectively deploying the associated portion for access along with the remaining portion of the markup document by the client browser.

2. The method of claim 1, wherein the associated portion comprises one of a header and a footer.

3. The method of claim 1, wherein accessing the stylesheet comprises obtaining a copy of the stylesheet from a computing device at which the markup document is deployed for access by a client browser, but at which the markup document does not yet include the associated portion.

4. The method of claim 1, further comprising enabling a user to preview with the administrator browser a rendering of the associated portion without the remainder of the markup document.

5. The method of claim 1, wherein enabling a user to edit comprises providing the administrator browser with a text editing control that enables a user to modify source markup code defining the associated portion.

6. The method of claim 1, further comprising enabling a user to store at least one of:
a preview version of the associated portion that can be rendered by the administrator browser but not directly deployable with the remaining portion of the markup document;
an active version of the associated portion that can be rendered by the administrator browser and directly deployable with the remaining portion of the markup document; and
a rollback version of the associated portion that comprises a previously saved active version and can replace the active version.

7. The method of claim 1, wherein enabling a user to preview comprises rendering with the administrator browser the associated portion together with the remaining portion according to the stylesheet, wherein the associated portion is not yet deployed for access by a client browser.

8. The method of claim 1, further comprising enabling a user to render the associated portion without the remaining portion using the administrator browser.

9. The method of claim 1, further comprising validating source markup code of the associated portion prior to enabling a user to preview the rendering of the markup document including the associated portion.

10. The method of claim 1, further comprising providing a set of configuration parameters to a plurality of servers that use the configuration parameters to deploy the associated portion together with the remaining portion.

11. A machine readable medium storing machine instructions that cause a processor to perform the operations of claim 1.

12. A system comprising for managing the rendered appearance of a markup document, comprising:
a processor;
a display in communication with the processor; and
an input device in communication with the processor and enabling a user to input data and instructions; and
a memory in communication with the processor and storing data and machine instructions that cause the processor to perform the operations of:
accessing a stylesheet that defines formatting for rendering the markup document;
enabling a user to edit an associated portion of the markup document with the input device and interacting with an administrator browser, wherein the associated portion is selectively deployable with a remaining portion of the markup document for access by a client browser; and
enabling a user to preview with the display and the administrator browser a rendering of the markup document including the associated portion according to the formatting defined by the stylesheet, prior to selectively deploying the associated portion for access along with the remaining portion of the markup document by the client browser.

13. The system of claim 12, wherein the associated portion comprises one of a header and a footer.

14. The system of claim 12, further comprising a communication interface and wherein accessing the stylesheet comprises obtaining a copy of the stylesheet from a computing device at which the markup document is deployed for access by a client browser, but at which the markup document does not yet include the associated portion.

15. The system of claim 12, wherein the machine instructions further cause the processor to perform the operation of enabling a user to preview with the display and the administrator browser a rendering of the associated portion without the remainder of the markup document.

16. The system of claim 12, wherein the machine instructions further cause the processor to perform the operation of providing the administrator browser with a text editing control that enables a user to modify source markup code defining the associated portion.

17. The system of claim 12, wherein the machine instructions further cause the processor to perform the operation of enabling a user to store in the memory at least one of:
a preview version of the associated portion that can be rendered by the administrator browser but not directly deployable with the remaining portion of the markup document;
an active version of the associated portion that can be rendered by the administrator browser and directly deployable with the remaining portion of the markup document; and
a rollback version of the associated portion that comprises a previously saved active version and can replace the active version.

18. The system of claim 12, wherein the machine instructions further cause the processor to perform the operation of rendering on the display with the administrator browser the associated portion together with the remaining portion according to the stylesheet, wherein the associated portion is not yet deployed for access by a client browser.

19. The system of claim 12, wherein the machine instructions further cause the processor to perform the operation of validating source markup code of the associated portion prior to enabling a user to preview on the display the rendering of the markup document including the associated portion.

20. The system of claim 12, further comprising a communication interface and wherein the machine instructions further cause the processor to perform the operation of providing a set of configuration parameters to a plurality of servers that use the configuration parameters to deploy the associated portion together with the remaining portion.

21. A method for managing an appearance of a Web page, comprising:
rendering a selected portion of the Web page with a browser in a first browser window to create a preview portion, wherein the preview portion is rendered without a remaining portion of the Web page;
displaying in the first browser window, together with the preview portion, source markup code of the selected portion of the Web page, wherein the source markup code can be edited through the first browser window;
accessing a stylesheet defining formatting for the Web page;
rendering the selected portion and the remaining portion together in a separate browser window according to the stylesheet.

22. The method of claim 21, wherein the remaining portion of the Web page is deployed for access through a network by a client browser and the selected portion of the Web page is not deployed for access through the network by a client browser.
